(19) United States
(12) Patent Application Publication
(10) Pub. No.: US 2023/0196361 A1
(43) Pub. Date: Jun. 22, 2023

(54) SYSTEM AND METHOD PROVIDING AN ELECTRONIC CENTRALIZED GATEWAY SWITCH TO A PLURALITY OF NETWORK DEVICES

(71) Applicant: BANK OF AMERICA CORPORATION, Charlotte, NC (US)

(72) Inventors: Paul Martin Mattison, Sherrills Ford, NC (US); David Smiddy, Chadds Ford, PA (US); Ann Ta, Scottsdale, AZ (US); Charles Hector Gruesbeck, II, Mint Hill, NC (US)

(73) Assignee: BANK OF AMERICA CORPORATION, Charlotte, NC (US)

(21) Appl. No.: 17/553,130

(22) Filed: Dec. 16, 2021

(51) Int. Cl. G06Q 20/40

(52) U.S. Cl. CPC G06Q 20/4014; G06Q 20/403; G06Q 20/405; G06Q 20/4015

(57) ABSTRACT

Systems, methods, and computer program products are provided for providing an electronic centralized gateway switch to a plurality of network devices. The method includes assigning a resource value to a resource received from a sending user. The resource value corresponds to a value of the resource received. The method also includes receiving a resource transfer information. The resource transfer information includes intended transfer target information corresponding to an intended transfer target account associated with an intended transfer target. The intended transfer target account is associated with one of a plurality of resource entities. The method further includes connecting to the resource entity associated with the intended transfer target account based on the resource entity associated with the intended transfer target account. The method still further includes causing a transmission of the resource value to the intended transfer target account at the resource entity associated with the intended transfer target account.

### TECHNOLOGICAL FIELD

An example embodiment relates generally to providing access to a plurality of network devices, and more particularly, to providing an electronic centralized gateway switch to a plurality of network devices.

### BACKGROUND

An automated teller machine (ATM) and other devices are typically associated with a single entity, thereby making it difficult or expensive for a user that has an account with a different entity to use such a device. As such, it can be difficult to facilitate transactions with different entities without increased cost or complexity. There exists a need for a system that can quickly and efficiently provide a centralized interface to interact with a plurality of third party financial institutions.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for providing an electronic centralized gateway switch to a plurality of network devices is provided. The system includes at least one non-transitory storage device and at least one processing device coupled to the at least one non-transitory storage device. The at least one processing device is configured to assign a resource value to a resource received from a sending user. The resource value corresponds to a value of the resource received. The at least one processing device is also configured to receive a resource transfer information. The resource transfer information includes intended transfer target information corresponding to an intended transfer target account associated with an intended transfer target. The intended transfer target account is associated with one of a plurality of resource entities. The at least one processing device is further configured to connect to the resource entity associated with the intended transfer target account. The at least one processing device is still further configured to cause a transmission of the resource value to the intended transfer target account at the resource entity associated with the intended transfer target account.

In some embodiments, the at least one processing device is further configured to validate an identity of at least one of the sending user or the intended transfer target. In some embodiments, validating the identity of at least one of the sending user or the intended transfer target includes determining one or more transfer requirements based on the identity of the sending user or the intended transfer target. In some embodiments, at least one of the one or more transfer requirements is based on the location of the sending user or the intended transfer target. In some embodiments, the one or more transfer requirement includes a resource transfer maximum with the resource transfer maximum corresponding to a maximum resource value allowed in a given transmission.

In some embodiments, the at least one processing device is further configured to cause a rendering of a user interface with the user interface providing the sending user with information relating to the resource transfer information. In some embodiments, the resource transfer information includes at least one of an identifier of the intended transfer target account or an identifier of the resource entity associated with the intended transfer target account.

In another example embodiment, a computer program product for providing an electronic centralized gateway switch to a plurality of network devices is provided. The computer program product includes at least one non-transitory computer-readable medium having computer-readable program code portions embodied therein. The computer-readable program code portions include an executable portion configured to assign a resource value to a resource received from a sending user. The resource value corresponds to a value of the resource received. The computer-readable program code portions also include an executable portion configured to receive a resource transfer information with the resource transfer information including intended transfer target information. The intended transfer target information corresponds to an intended transfer target account associated with an intended transfer target and the intended transfer target account is associated with one of a plurality of resource entities. The computer-readable program code portions further include an executable portion configured to connect to the resource entity associated with the intended transfer target account based on the resource entity associated with the intended transfer target account. The computer-readable program code portions still further include an executable portion configured to cause a transmission of the resource value to the intended transfer target account at the resource entity associated with the intended transfer target account.

In some embodiments, the computer-readable program code portions also include an executable portion configured to validate an identity of at least one of the sending user or the intended transfer target. In some embodiments, validating the identity of at least one of the sending user or the intended transfer target includes determining one or more transfer requirements based on the identity of the sending user or the intended transfer target. In some embodiments, at least one of the one or more transfer requirements is based on the location of the sending user or the intended transfer target. In some embodiments, the one or more transfer requirement includes a resource transfer maximum and the resource transfer maximum corresponds to a maximum resource value allowed in a given transmission.

In some embodiments, the computer-readable program code portions also include an executable portion configured to cause a rendering of a user interface with the user interface providing the sending user with information relating to the resource transfer information. In some embodiments, the resource transfer information includes at least one of an identifier of the intended transfer target account or an identifier of the resource entity associated with the intended transfer target account.

In still another example embodiment, a computer-implemented method for providing an electronic centralized gateway switch to a plurality of network devices is provided. The method includes assigning a resource value to a resource received from a sending user. The resource value corresponds to a value of the resource received. The method also includes receiving a resource transfer information with the resource transfer information including intended transfer target information. The intended transfer target information corresponds to an intended transfer target account associated with an intended transfer target and the intended transfer target account is associated with one of a plurality of resource entities. The method further includes connecting to the resource entity associated with the intended transfer target account. The method still further includes causing a transmission of the resource value to the intended transfer target account at the resource entity associated with the intended transfer target account.

In some embodiments, the method also includes validating an identity of at least one of the sending user or the intended transfer target. In some embodiments, validating the identity of at least one of the sending user or the intended transfer target includes determining one or more transfer requirements based on the identity of the sending user or the intended transfer target. In some embodiments, at least one of the one or more transfer requirements is based on the location of the sending user or the intended transfer target. In some embodiments, the one or more transfer requirement includes a resource transfer maximum with the resource transfer maximum corresponding to a maximum resource value allowed in a given transmission. In some embodiments, the resource transfer information includes at least one of an identifier of the intended transfer target account or an identifier of the resource entity associated with the intended transfer target account.

Embodiments of the present disclosure address the above needs and/or achieve other advantages by providing apparatuses (e.g., a system, computer program product and/or other devices) and methods for dynamically generating optimized data queries to improve hardware efficiency and utilization. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for providing an electronic centralized gateway switch to a plurality of network devices, in accordance with embodiments of the present disclosure;

FIG. 2 provides a block diagram illustrating the entity system 200 of FIG. 1, in accordance with embodiments of the present disclosure;

FIG. 3 provides a block diagram illustrating a target resource entity determination device 300 of FIG. 1, in accordance with embodiments of the present disclosure;

FIG. 4 provides a block diagram illustrating the computing device system 400 of FIG. 1, in accordance with embodiments of the present disclosure; and

FIG. 5 provides a flowchart illustrating a method of providing an electronic centralized gateway switch to a plurality of network devices in accordance with embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

ATMs are often branded machines that only natively support the given financial institution customers. Network limitations make capabilities of ATMs across different financial institutions limited or costly, often resulting in costs to a given financial institution’s consumer to use another financial institution’s ATM. As a result, there are often multiple ATM associated with different entities in the same area resulting in wasted space and money. Therefore, there exists a need to provide an electronic centralized gateway switch to a plurality of network devices associated with different entities.

Various embodiments of the present disclosure allow for users to transfer resources, such as cash, deposited into an ATM to other users across a plurality of resource entities (e.g., financial institutions). Upon receiving the resource from the sending user, the system assigns a resource value to the resource. The sending user also provides resource transfer information that corresponds to the intended transfer target, such as a phone number or email address. The system determines the resource entity associated with the intended transfer target and communicates with said resource entity system in order to facilitate the transfer. As such, the sending user can deposit a resource, such as cash, into an ATM and transfer said the value of said resource to another user account at one of a plurality of financial institutions.

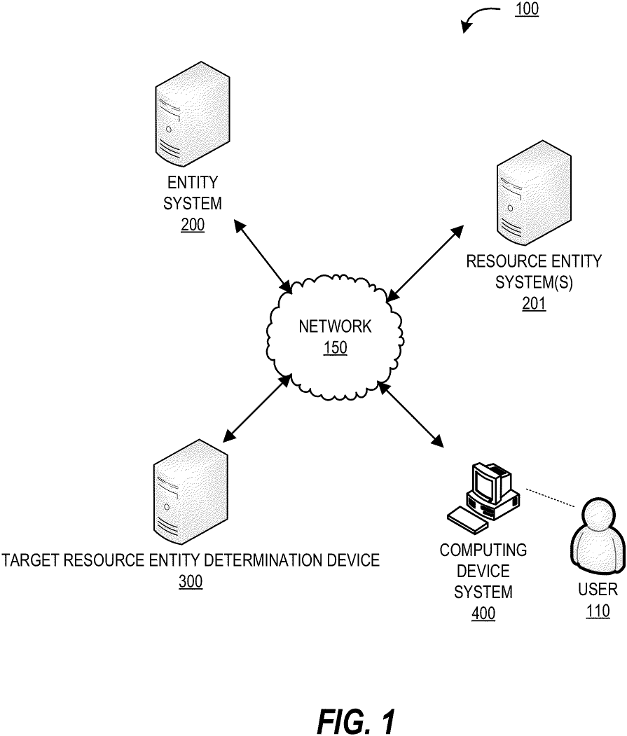

FIG. 1 provides a block diagram illustrating a system environment 100 for providing an electronic centralized gateway switch to a plurality of network devices. As illustrated in FIG. 1, the environment 100 includes a target resource entity determination device 300, an entity system 200, one or more resource entity systems 201, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities. In some embodiments, the entity system(s) 200 may be associated with a facilitating entity that provides centralized transfer capabilities with one or more resource entity system(s) 201.

The resource entity system(s) 201 may be any system owned or otherwise controlled by a third party resource entity (e.g., distinct from the facilitating entity associated with entity system(s) 200). In some embodiments, the resource entity is a financial institution. In some embodiments, the resource entity may be a non-financial institution. In some embodiments, the resource entity may be any organization that utilizes one or more resource entity resources to perform one or more organizational activities. The resource entity system(s) 201 may store account information relating to one or more user accounts.

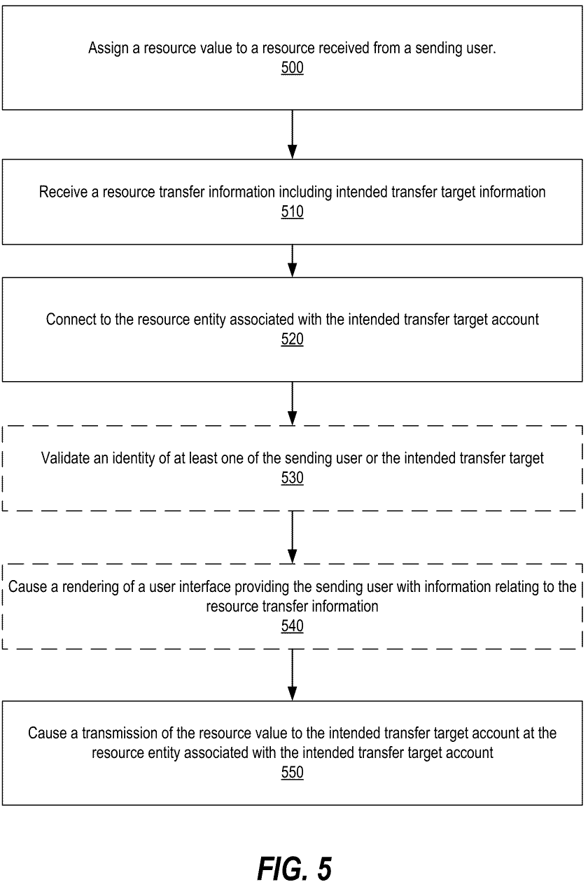

The target resource entity determination device 300 is a system of the present disclosure for performing one or more process steps described herein. In some embodiments, the target resource entity determination device 300 may be an independent system. In some embodiments, the target resource entity determination device 300 may be a part of the entity system 200. For example, the method of FIG. 5 may be carried out by the entity system 200, the resource entity system(s) 201, the target resource entity determination device 300, the computing device system 400, and/or a combination thereof.

The target resource entity determination device 300, the entity system 200, the resource entity system(s) 201, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the target resource entity determination device 300 is configured to communicate information or instructions with the entity system 200, and/or the computing device system 400 across the network 150. While the entity system 200, the target resource entity determination device 300, and the computing device system 400 are illustrated as separate components communicating via network 150, one or more of the components discussed here may be carried out via the same system (e.g., a single system may include the entity system 200 and the target resource entity determination device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the target resource entity determination device 300, and/or entity system 200 across the network 150.

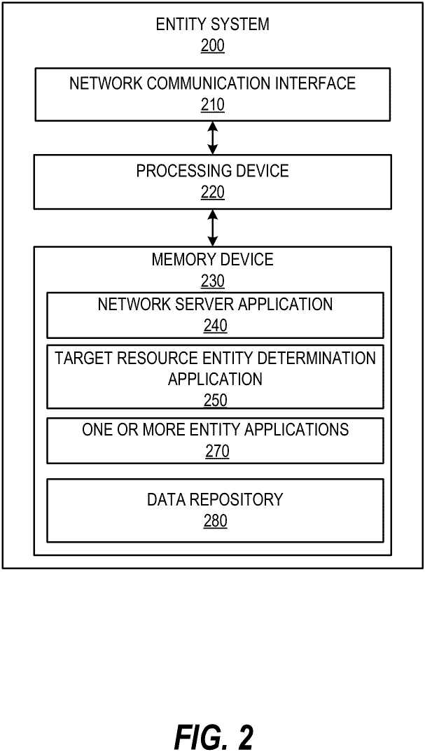

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a target resource entity determination application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the target resource entity determination application 250, the one or more entity application 270 to perform certain logic, data-extraction, and data-storing functions of the entity system 200 described herein, as well as communication functions of the entity system 200.

The network server application 240, the target resource entity determination application 250, and the one or more entity applications 270 are configured to store data in the data repository 280 or to use the data stored in the data repository 280 when communicating through the network communication interface 210 with the target resource entity determination device 300, and/or the computing device system 400 to perform one or more process steps described herein. In some embodiments, the entity system 200 may receive instructions from the target resource entity determination device 300 via the target resource entity determination application 250 to perform certain operations. The target resource entity determination application 250 may be provided by the target resource entity determination device 300. The one or more entity applications 270 may be any of the applications used, created, modified, facilitated, and/or managed by the entity system 200.

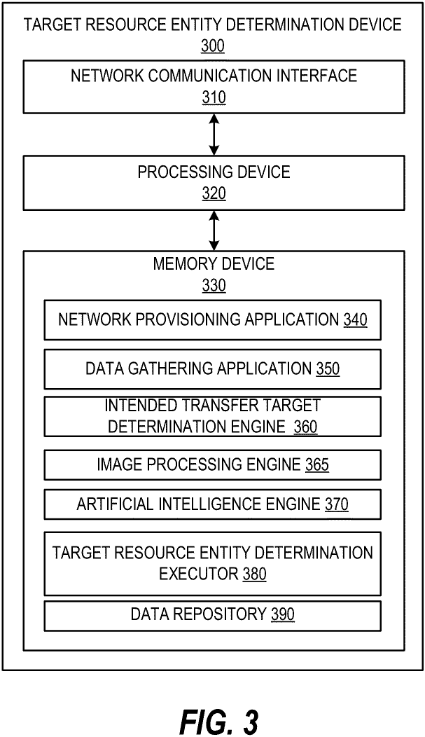

FIG. 3 provides a block diagram illustrating the target resource entity determination device 300 in greater detail, in accordance with various embodiments. As illustrated in FIG. 3, in one embodiment, the target resource entity determination device 300 includes one or more processing devices 320 operatively coupled to a network communication interface 310 and a memory device 330. In certain embodiments, the target resource entity determination device 300 is operated by an entity, such as a financial institution. In some embodiments, the target resource entity determination device 300 is owned or operated by the entity of the entity system 200. In some embodiments, the target resource entity determination device 300 may be an independent system. In alternate embodiments, the target resource entity determination device 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the target resource entity determination device 300 described herein. For example, in one embodiment of the target resource entity determination device 300, the memory device 330 includes, but is not limited to, a network provisioning application 340, a data gathering application 350, an intended transfer target determination engine 360, an image processing engine 365, an artificial intelligence engine 370, a target resource entity determination executor 380, and a data repository 390 comprising any data processed or accessed by one or more applications in the memory device 330. The computer-executable program code of the network provisioning application 340, the data gathering application 350, the intended transfer target determination engine 360, the image processing engine 365, the artificial intelligence engine 370, and the target resource entity determination executor 380 may instruct the processing device 320 to perform certain logic, data-processing, and data-storing functions of the target resource entity determination device 300 described herein, as well as communication functions of the target resource entity determination device 300.

The intended transfer target determination engine 360, the artificial intelligence engine 365, and/or the target resource entity determination executor 380 may alone, or in combination, be configured to determine the intended transfer target based on the resource transfer information and determine the resource entity associated with the intended transfer target account. The intended transfer target determination engine 360, the artificial intelligence engine 365, and/or the target resource entity determination executor 380 may include a user database generated to assist in determining the intended transfer target and a resource entity database generated to assist in determining the resource entity associated with the intended transfer target account. The user database and the resource entity database may be separate or combined (e.g., within data repository 390 or elsewhere within the memory device 330).

The network provisioning application 340, the data gathering application 350, the intended transfer target determination engine 360, the image processing engine 365, the artificial intelligence engine 370, and the target resource entity determination executor 380 are configured to invoke or use the data in the data repository 390 when communicating through the network communication interface 310 with the entity system 200, and/or the computing device system 400. In some embodiments, the network provisioning application 340, the data gathering application 350, the intended transfer target determination engine 360, the image processing engine 365, the artificial intelligence engine 370, and the target resource entity determination executor 380 may store the data extracted or received from the entity system 200, and the computing device system 400 in the data repository 390. In some embodiments, the network provisioning application 340, the data gathering application 350, the intended transfer target determination engine 360, the image processing engine 365, the artificial intelligence engine 370, and the target resource entity determination executor 380 may be a part of a single application.

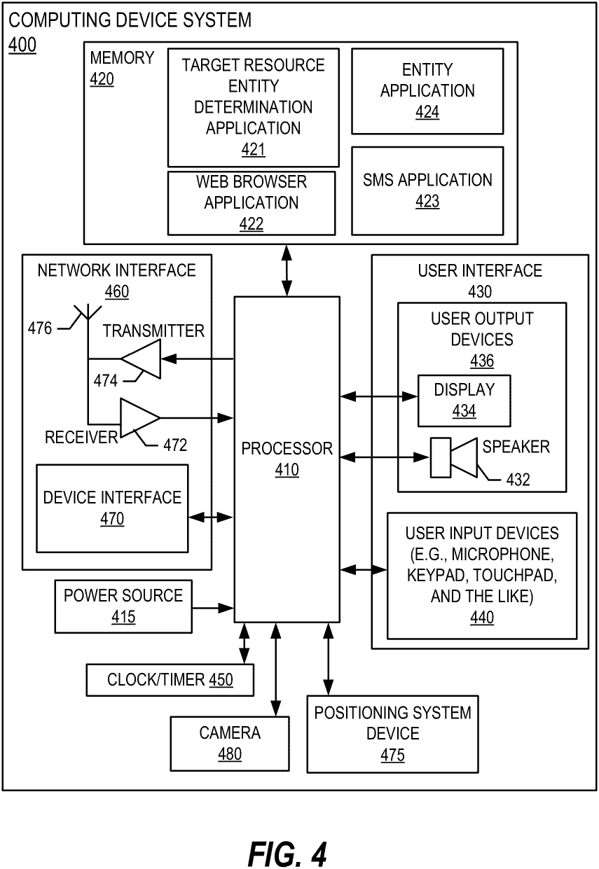

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, electronic media devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include one or more displays 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a target resource entity determination application 421, entity application 424. These applications also typically instructions to a graphical user interface (GUI) on the display 430 that allows the user 110 to interact with the entity system 200, the target resource entity determination device 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the target resource entity determination application 421 provided by the target resource entity determination device 300 allows the user 110 to access the target resource entity determination device 300. In some embodiments, the entity application 424 provided by the entity system 200 and the target resource entity determination application 421 allow the user 110 to access the functionalities provided by the target resource entity determination device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

Referring now to FIG. 5, a method of providing an electronic centralized gateway switch to a plurality of network devices is provided. The method may be carried out by a system discussed herein (e.g., the entity system 200, the target resource entity determination device 300, and/or the computing device system 400). The system may also be in communication with one or more resource entities systems 201 associated with resource entities distinct from the entity associated with the entity system 200. An example system may include at least one non-transitory storage device and at least one processing device coupled to the at least one non-transitory storage device. In such an embodiment, the at least one processing device is configured to carry out the method discussed herein.

Referring now to Block 500 of FIG. 5, the method may include assigning a resource value to a resource received from a sending user. The resource may be received in an ATM or other computing device system 400 (e.g., the sending user may deposit the resource into an ATM). The resource received from the sending user may be a currency, such as fiat currency. The resource received from the sending user may be physical currency (e.g., the sending user may input cash into an ATM).

The system assigns a resource value that corresponds to the value of the resource received. The resource value may be representative of the value of the resource (e.g., in an instance in which the sending user deposits $100 into an ATM for transfer, the resource value may be $100). In some embodiments, the resource value may be in the native resource type (e.g., if U.S. currency is inputted by the sending user, then the resource value would be U.S. Dollars). In some instances, the resource value may be uniform resource type (e.g., the value of a given resource is converted into the uniform resource type and then assigned a resource value in the uniform resource type). For example, an ATM in a given country may assign a resource value based on the given country’s fiat currency and therefore in an instance in which a different currency is inputted by the sending user, the value of the resource is converted into the value in the given country’s fiat currency.

Additionally or alternatively, the resource may be a cryptocurrency. In such an embodiment, the sending user may input wallet information or another type of identification that allows the given cryptocurrency to be transferred to the entity system 200. For example, the sending user may scan a QR code corresponding to the sending user’s crypto wallet and a corresponding blockchain transaction is processed.

Additionally, the system may also use blockchain technology to represent physical resources that are received by an ATM. For example, the resource value may be stored using blockchain technology in order to create a detailed record of inputted resources including transfers to other resource entities. The resource value is a digital representation of the physical resource. As such, the resource value can be transferred to different users without necessarily transferring possession of the physical resource at the time of transfer (e.g., the facilitating entity may hold the physical resource for a period of time after the resource value has been transferred to the transfer resource entity).

Referring now to Block 510 of FIG. 5, the method may include receiving a resource transfer information including intended transfer target information. In addition to the resource received from the sending user, the sending user can also provide resource transfer information with information relating to intended transfer target. The system is configured to facilitate transfers across a plurality of resource entities, such as different financial institutions. The resource entities may include the entity system 200 itself (e.g., the facilitating entity), as well as third party resource entities. For example, a first financial institution may be the facilitating entity and the entity system 200 may be configured to communicate with one or more other resource entity systems 201 that are associated with one or more other financial institutions to facilitate transfers to the given resource entity.

In some embodiments, the resource transfer information may include one or more identifiers of the intended transfer target account. The resource transfer information may include the intended transfer target’s name, phone number, email address, account number, and/or other identification number. The information may be enough to find the intended transfer target account for the intended transfer target (e.g., the intended transfer target’s account number may link the system directly to the intended transfer target account).

Alternatively, the resource transfer information may be enough for the system to contact the intended transfer target for information relating to the intended transfer target account associated with the intended transfer target. For example, the sending user may provide a phone number or email address of the intended transfer target and the system provides a communication to the intended transfer target to accept the intended transfer and additionally provide details relating to the intended transfer target’s desired intended transfer target account. In some embodiments, in an instance in which the intended transfer target contact information (e.g., phone number or email address) is provided, a request for confirmation of the intended transfer target account may be transmitted to the intended transfer target. For example, the intended transfer target may receive an email asking said intended transfer target to confirm the intended transfer target account and confirm the transfer.

In some instances, the system may store intended transfer target account information relating to resource transfer information, such as user contact information like phone number or email address. For example, a user may be capable of saving a specific account as a primary account, such that in an instance in which a sending user provides a phone number or email address for the user, that the primary account is used as the intended transfer target account. In such embodiments, users may be assigned a system account that is used to facilitate future transfers (e.g., a sending user and/or an intended transfer target may be allowed to create an account for future use).

Additionally or alternatively, the resource transfer information may include one or more identifiers of the resource entity associated with the intended transfer target account. The sending user may indicate the resource entity (e.g., financial institution) that is associated with the intended transfer target account. For example, the user interface may request the sending user input the resource entity associated with the intended transfer target account. In some instances, the sending user may be presented a list of one or more participating resource entities in which the entity system 200 is capable of facilitating a transfer. In some instances, the resource transfer information may include a routing number or other resource entity identification number that allows the system to identify the resource entity that is associated with the intended transfer target account.

In some embodiments, the resource transfer information may include one or more identifiers for both the intended transfer target account and the resource entity associated with the intended transfer target account. For example, the resource transfer information may include both a routing number that corresponds to a given resource entity and an account number that corresponds to intended transfer target account.

Referring now to Block 520 of FIG. 5, the method may include connecting to the resource entity associated with the intended transfer target account. The system may be configured to communicate with one or more resource entity system 201 associated with one or more resource entities via network 150 shown in FIG. 1. In various embodiments, the entity system 200 may be configured to communicate with the resource entity system(s) 201 in order to facilitate the operations discussed herein.

In some embodiments, the system is configured to determine the resource entity associated with the intended transfer target account, as discussed above in reference to Block 510 of FIG. 5. Upon determination of the resource entity associated with the intended transfer target account, the system is configured to connect with the given resource entity. In some embodiments, the system may already be in communication with the resource entity associated with the intended transfer target account and connecting with the given resource entity corresponds to contacting the resource entity for a specific communication session with the resource entity associated with the intended transfer target account relating to the given transfer. Alternatively, in an instance in which the system is not already in communication with the resource entity associated with the intended transfer target account, the system may be configured to contact and register a new connection between the entity system 200 and the resource entity system associated with the new resource entity.

Referring now to optional Block 530 of FIG. 5, the method may include validating an identity of at least one of the sending user or the intended transfer target. Transfers of resources may be restricted based on location or citizenship of a given user. For example, transfers between users in different countries may be subject to restrictions (e.g., to reduce malfeasance or to adhere to specific country laws on such transfers). Additionally, some governments may impose transfer restrictions based on transfer amount or other transfer information (e.g., some countries have anti-money laundering laws for international transactions). For example, the government may require a user to submit additional information relating to large transfers. As such, the system may be configured to validate the identity of the sending user and/or the intended transfer target in order to confirm that the transfer is legal. Additionally, validating the identity of the sending user and/or the intended transfer target may be used for other security purposes (e.g., ensure that the intended transfer target is the correct user that the sending user wants to transfer said resource).

In some embodiments, validating the identity of at least one of the sending user or the intended transfer target includes determining one or more transfer requirements based on the identity of the sending user or the intended transfer target. Transfer requirement(s) may include requiring additional information before allowing the transfer, limiting the resource transfer maximum for a given transmission, completely restricting the transfer, and/or the like. The transfer requirement(s) may be based on the location of at least one of the sending user or the intended transfer target. The transfer requirement(s) may also be based on other attributes based on the identity of the sending user and/or the intended transfer target. For example, the transfer may be restricted (e.g., the resource transfer maximum is reduced) in an instance in which the sending user and the intended transfer target have not had a previous transfer.

The system may be configured to screen for potential necessary transfer requirements. For example, the system may be programmed for legal or security purposes to flag and/or institute transfer requirements during the operations discussed herein. The screening may be based on the validated identity. Additionally or alternatively, the screening may be based on the resource transfer information received by the system. In an example embodiment, some types of resource transfer information may be more secure than others, such that larger transfer limits may be allowed for some types of resource transfer information. For example, an account number may be more secure than a phone number and as such the resource transfer maximum may be higher in an instance in which the account number for the intended transfer target account is provided than in an instance in which a phone number associated with the intended transfer target is provided.

Referring now to optional Block 540 of FIG. 5, the method may include causing a rendering of a user interface providing the sending user with information relating to the resource transfer information. The user interface may be on a computing device system 400, such as an ATM. In an example embodiment, the user interface may change based on the resource entity associated with the intended transfer target account (e.g., the entity system 200 may access the resource entity system 201 associated with the resource entity associated with the intended transfer target account and provide a user interface based on said communication). The system may facilitate the entire process discussed herein via the user interface. For example, the sending user may be prompted to provide the resource transfer information via the user interface and be prompted for any additional information during the operations. Additionally, the user interface may be configured to provide notifications relating to the transfer (e.g., status of the transfer with the resource entity associated with the intended transfer target account).

In some embodiments, the computing device system 400 may include a plurality of displays corresponding to different resource entities. For example, the computing device system 400 may be an ATM with rotating screens, in which each screen has a user interface relating to a different resource entity. In some embodiments, the computing device system 400 may have a singular screen with distinct user interfaces corresponding to different resource entities (e.g., the sending user may scroll through the available resource entities and be presented with the user interface corresponding to the resource entity selected).

Referring now to Block 550 of FIG. 5, the method may include causing a transmission of the resource value to the intended transfer target account at the resource entity associated with the intended transfer target account. The entity system 200 may communicate with the resource entity associated with the intended transfer target account to notify said resource entity that a resource corresponding to the given resource value has been deposited by the sending user. As such, the resource entity associated with the intended transfer target account is capable of crediting the intended transfer target account with the resource value before actually possessing the resource, as the resource is owed from the facilitating entity to the resource entity.

In some embodiments, the facilitating entity associated with the entity system 200 may maintain physical possession of the resource for a period of time after the resource value is communicated to the resource entity associated with the intended transfer target account. The resource may be earmarked as owned by the resource entity associated with the intended transfer target account. The facilitating entity and the given resource entities may periodically settle the resource possession, such that the facilitating entity provides a given resource entity with the resource (or a resource of the same value) to the resource entity.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for providing an electronic centralized gateway switch to a plurality of network devices, the system comprising:
at least one non-transitory storage device; and
at least one processing device coupled to the at least one non-transitory storage device, wherein the at least one processing device is configured to:
assign a resource value to a resource received from a sending user, wherein the resource value corresponds to a value of the resource received;
receive a resource transfer information, wherein the resource transfer information comprises intended transfer target information, wherein the intended transfer target information corresponds to an intended transfer target account associated with an intended transfer target, wherein the intended transfer target account is associated with one of a plurality of resource entities;
connect to the resource entity associated with the intended transfer target account; and
cause a transmission of the resource value to the intended transfer target account at the resource entity associated with the intended transfer target account.

2. The system of claim 1, wherein the at least one processing device is further configured to validate an identity of at least one of the sending user or the intended transfer target.

3. The system of claim 2, wherein validating the identity of at least one of the sending user or the intended transfer target comprises determining one or more transfer requirements based on the identity of the sending user or the intended transfer target.

4. The system of claim 3, wherein at least one of the one or more transfer requirements is based on the location of the sending user or the intended transfer target.

5. The system of claim 3, wherein the one or more transfer requirement comprises a resource transfer maximum, wherein the resource transfer maximum corresponds to a maximum resource value allowed in a given transmission.

6. The system of claim 1, wherein the at least one processing device is further configured to cause a rendering of a user interface, wherein the user interface provides the sending user with information relating to the resource transfer information.

7. The system of claim 1, wherein the resource transfer information comprises at least one of an identifier of the intended transfer target account or an identifier of the resource entity associated with the intended transfer target account.

8. A computer program product for providing an electronic centralized gateway switch to a plurality of network devices, the computer program product comprising at least one non-transitory computer-readable medium having computer-readable program code portions embodied therein, the computer-readable program code portions comprising:
an executable portion configured to assign a resource value to a resource received from a sending user, wherein the resource value corresponds to a value of the resource received;
an executable portion configured to receive a resource transfer information, wherein the resource transfer information comprises intended transfer target information, wherein the intended transfer target information corresponds to an intended transfer target account associated with an intended transfer target, wherein the intended transfer target account is associated with one of a plurality of resource entities;
an executable portion configured to connect to the resource entity associated with the intended transfer target account; and
an executable portion configured to cause a transmission of the resource value to the intended transfer target account at the resource entity associated with the intended transfer target account.

9. The computer program product of claim 8, wherein the computer-readable program code portions also comprise an executable portion configured to validate an identity of at least one of the sending user or the intended transfer target.

10. The computer program product of claim 9, wherein validating the identity of at least one of the sending user or the intended transfer target comprises determining one or more transfer requirements based on the identity of the sending user or the intended transfer target.

11. The computer program product of claim 10, wherein at least one of the one or more transfer requirements is based on the location of the sending user or the intended transfer target.

12. The computer program product of claim 10, wherein the one or more transfer requirement comprises a resource transfer maximum, wherein the resource transfer maximum corresponds to a maximum resource value allowed in a given transmission.

13. The computer program product of claim 8, wherein the computer-readable program code portions also comprise an executable portion configured to cause a rendering of a user interface, wherein the user interface provides the sending user with information relating to the resource transfer information.

14. The computer program product of claim 8, wherein the resource transfer information comprises at least one of an identifier of the intended transfer target account or an identifier of the resource entity associated with the intended transfer target account.

15. A computer-implemented method for providing an electronic centralized gateway switch to a plurality of network devices, the method comprising:
assigning a resource value to a resource received from a sending user, wherein the resource value corresponds to a value of the resource received;
receiving a resource transfer information, wherein the resource transfer information comprises intended transfer target information, wherein the intended transfer target information corresponds to an intended transfer target account associated with an intended transfer target, wherein the intended transfer target account is associated with one of a plurality of resource entities;
connecting to the resource entity associated with the intended transfer target account; and
causing a transmission of the resource value to the intended transfer target account at the resource entity associated with the intended transfer target account.

16. The method of claim 15, further comprising validating an identity of at least one of the sending user or the intended transfer target.

17. The method of claim 16, wherein validating the identity of at least one of the sending user or the intended transfer target comprises determining one or more transfer requirements based on the identity of the sending user or the intended transfer target.

18. The method of claim 17, wherein at least one of the one or more transfer requirements is based on the location of the sending user or the intended transfer target.

19. The method of claim 17, wherein the one or more transfer requirement comprises a resource transfer maximum, wherein the resource transfer maximum corresponds to a maximum resource value allowed in a given transmission.

20. The method of claim 15, wherein the resource transfer information comprises at least one of an identifier of the intended transfer target account or an identifier of the resource entity associated with the intended transfer target account.
